(19) United States
(12) Patent Application Publication
(10) Pub. No.: US 2006/0148493 A1
(43) Pub. Date: Jul. 6, 2006

(54) Paging for broadcast and multicast services

(76) Inventors: Murali Narasimha, Grayslake, IL (US); Sean S. Kelley, Barrington, IL (US)

Correspondence Address: LAW OFFICES OF CHARLES W. BETHARDS, LLP, P.O. BOX 1622, COLLEYVILLE, TX, 76034, US

(21) Appl. No.: 11/026,445

(22) Filed: Dec. 30, 2004

(51) Int. Cl. H04Q 7/20

(52) U.S. Cl. 455/458

(57) ABSTRACT

Paging is provided in a communication network, and implemented in a network infrastructure device (101). Multiple flows including a particular flow are assigned to one or more flow groups. Flow groups, including the foregoing flows, are assigned to at least one paging category, wherein the flow groups have a first paging slot. The paging category is transmitted (107) to one or more communication units (103), wherein the communication unit(s) (103) has requested the particular flow.

### FIELD OF THE INVENTION

The present invention relates in general to wireless communication units and wireless networks, and more specifically to paging methods for wireless communication networks

### BACKGROUND OF THE INVENTION

BCMCS (broadcast/multicast service) is intended to provide a mechanism to transmit the same information to multiple users. A user can subscribe to one or more particular BCMCS transmissions, where the transmission is generally a broadcast to any communication device that can receive the transmission, or a multicast to particular communication devices. Inherent to the notion of broadcast and multicast is the notion of broadcast and multicast groups.

BCMCS is intended for use by applications such as mobile television, advertising and push-to-talk dispatch (PTT). For applications such as mobile television, communication devices can obtain information needed to start reception of a broadcast flow from overhead messages and thereafter can start reception of the broadcast flow.

For other applications, there can be a need for broadcast paging, for example group paging to all members of a PTT group. The motivation for group paging stems from the following observations. Most or all members of a group typically want to be in a communication session simultaneously. Moreover, most or all members of the group tend to interact with the same controlling entity in the network (for example a push-to-talk server).

As a consequence, excessive paging load can be experienced, particularly if a paging group is large. For example, where there is traffic for a large PTT group, a large number of communication devices might need to be individually paged. This can result in overload, and a consequence can be a reduced ability to establish connections during such overload.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating a simplified and representative environment associated with a communication unit and exemplary wireless networks arranged for paging for broadcast and/or multicast in accordance with various exemplary embodiments;

FIG. 2 is a diagram illustrating portions of an exemplary network infrastructure device in accordance with various exemplary embodiments;

FIG. 3 is a diagram illustrating portions of an exemplary communication unit in accordance with various exemplary embodiments;

FIG. 4 is a flow chart illustrating an exemplary page process in accordance with various exemplary embodiments;

FIG. 5 is a flow chart illustrating an exemplary listen for page procedure in accordance with various exemplary and alternative exemplary embodiments; and

FIG. 6 is a flow chart illustrating an exemplary procedure for determining a hash in accordance with various exemplary and alternative exemplary embodiments.

### DETAILED DESCRIPTION

In overview, the present disclosure concerns wireless communications devices or units, often referred to as communication units, such as cellular phone or two-way radios and the like having BCMCS (broadcast/multicast service) operating capability, such as can be associated with a communication system such as an Enterprise Network, a cellular Radio Access Network, or the like. Such communication systems may further provide services such as voice and data communications services. More particularly, various inventive concepts and principles are embodied in systems, network infrastructure devices, communication units, and methods therein for paging associated with a BCMCS transmission.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to reduce the number of paging slots that a communication device needs to monitor for any paging message, regardless of how many broadcast flows the communication device listens to, and to reduce the number of broadcast and/or multicast messages that are transmitted by a communication network.

Broadcast/multicast service (BCMCS) content is organized into “flows”. Conventionally, each flow is assigned a flow identifier. By way of example, a particular “flow” can be a broadcast (e.g., CNN or MTV), or multicast (e.g., a push-to-talk group (co-workers, friends, etc.)) to a group of users. A particular communication device can register for particular BCMCS content, e.g., by subscribing for a particular flow. Some flows can be generally continuous, referred to herein as “static”, whereas other flows can be discontinuous, referred to herein as “dynamic.” Conventional techniques currently provide for registering communication devices for particular flows, as well as for transmitting flows from the communication network to communication devices.

The flows that a communication device can receive simultaneously are limited by capabilities of the communication device. For example, communication devices using conventional technology cannot simultaneously receive more than one audio flow or more than one video flow. The conventional communication device might be capable of receiving an audio or a video flow simultaneously with a push-to-talk dispatch (direct connect) flow. Furthermore, the flows that can be simultaneously received are generally known to the network and can be controlled.

Consider the example of CDMA2000, where a communication device can be addressed by an international mobile station identifier (IMSI) and can receive a communication on a forward common signaling channel, sometimes referred to as a “paging channel.” A paging channel can be organized into one or more paging slots. A communication device can be configured to operate in a slotted mode in accordance with known techniques, that is, the communication device can wake up for only one paging slot in a “slot cycle” to receive a communication on the paging channel. This can allow the communication device to conserve battery power. The paging slot that the communication device can use to monitor the paging channel is conventionally determined by a standardized hash function that uses the IMSI of the communication device as one of the input parameters. The communication network can transmit messages directed to the communication device (including page messages) in the paging slot that the communication device is monitoring. It will be appreciated that multiple communication devices can hash to the same paging slot.

In order to page an entire broadcast or multicast group, the inventors have consider various approaches: (a) page each communication device in the group individually in its particular paging slot using its unique address; (b) page each communication device in the group in its particular paging slot using a common address; or (c) page each communication device in the group in a single common paging slot using a common address.

Approach (a) (paging each group member in its paging slot using its unique address) does not utilize the fact that the same information is to be delivered to all the communication devices in the group. Consequently, even if multiple communication devices hash to the same paging slot, different page messages will be sent to each of the communication devices in that paging slot.

Approach (b) (paging each group member in its paging slot using a common address) provides some benefit: if multiple communication devices in the group hash to the same paging slot they can be sent a single page message rather than multiple page messages.

Approach (c) (page all group members in the group's common paging slot) can be useful for groups whose membership is static, but is not practical for groups where members of the group change. Moreover, a communication device that is a member of more than one group can have multiple group addresses, and may need to wake up multiple times in a paging slot cycle to listen for each of its group addresses and its unique address.

One or more embodiments can utilize and/or improve upon various aspects of the above approaches. Further in accordance with exemplary embodiments, there can be provided an improved paging capacity on a wireless communication network. Paging slots can be selectively shared for multiple flows. Consequently, a communication device can monitor as few as one paging slot in order to receive broadcast and/or multicast transmissions.

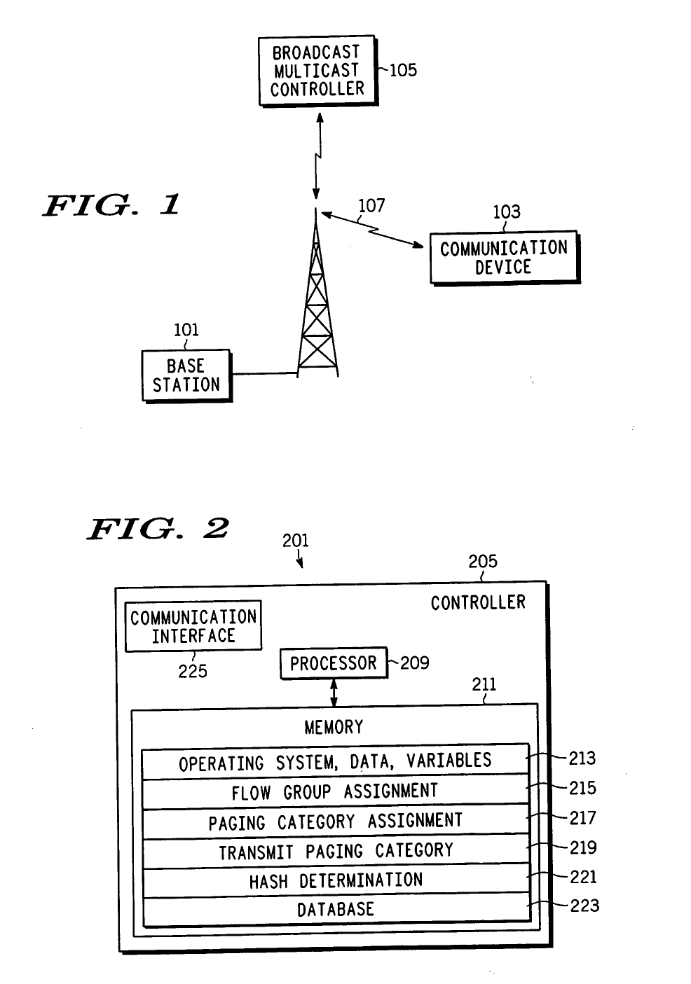

Referring now to FIG. 1, a diagram illustrating a simplified and representative environment associated with a communication unit and exemplary wireless networks arranged for paging for broadcast and/or multicast in accordance with various exemplary embodiments will be discussed and described. As illustrated, a communication network useful for broadcast/multicast can include one or more network infrastructure devices, here represented by a base station 101. The base station 101 and other network infrastructure devices can be managed by one or more broadcast multicast controller 105, as well as other infrastructure devices, in order to provide coordination between various network infrastructure devices. The network infrastructure devices can communicate with multiple communication devices, here represented by communications 107 between the base station 101 and a communication device 103.

In the present illustration, the base station 101 or other network infrastructure device, e.g., the broadcast multicast controller 105 can assign multiple flows to a flow group, such that they map to the same paging slot. Various functions can be used to determine the paging slot to that corresponds to a flow and/or a flow group. For example, one or more embodiments provides for determining the paging slot by utilizing a hash function (explained below) incorporating a flow identifier associated with a flow. A flow identifier for a particular flow can be assigned so that the flow identifier hashes to the paging slot that corresponds to the flow group to which the flow is assigned. Therefore, the paging slot can be common for each flow in the flow group. Further, multiple flows can be grouped into multiple flow groups, each of the flow groups corresponding to respective paging slots. Accordingly, a flow can be assigned to one (or more) flow groups. The determination of the paging slot will be described below. In general, if a communication device is registered to listen to two flows, the two flows can be assigned to the same paging slot (e.g., assigned to the same flow group) by assigning appropriate flow identifiers.

Various techniques further can provide for selecting the flows that should be grouped together. For example, a service provider can assign flow identifiers to, e.g., a “sports package” encompassing popular sports programs such that the programs in the package map to the same paging slot. As another example, the network operator, based on usage patterns by subscribers of the various flows, can determine the optimal constituent flows of a flow group. Alternatively, conventional statistical techniques can provide for determining which flows should be grouped together. Note that a channel indicator for a particular flow, e.g., a quick paging channel (QPCH) indicator may be different than other flows in its flow group.

Allocating flows to the same paging slot works well for static flows. However, for flows that can be established and de-established from time-to-time, referred to herein as dynamic flows, merely utilizing flow groups can be insufficient. An example of a dynamic flow is a PTT communication in a PTT group. One or more embodiments further can provide for assigning one or more flows or flow groups to one or more paging categories. A paging category, as used herein, indicates a grouping that can include one or more flow groups and/or one or more dynamic flows. The flows within a paging category can be assigned to the same paging slot, for one or more cycles of paging slots. Flow groups and/or dynamic flows assigned to a paging category can be re-assigned to other paging categories or can be de-assigned, e.g., from time-to-time. Advantageously, each paging category can be assigned to a different paging slot.

The paging category can be transmitted from a network infrastructure device, e.g., the base station 101 to communication units, e.g., the communication device 107, as further described below. The communication device 107 that receives the paging category may have requested one or more of the flows that are represented within the paging category, in accordance with conventional techniques, e.g., by registering for a particular flow and/or by listening for a particular flow. In accordance with alternative embodiments, the paging categories are transmitted to communication devices without determining which paging category corresponds to the communication devices' requested flows.

One or more embodiments can support paging categories encompassing static flows and/or dynamic flows. In accordance with one or more embodiments, the paging category advantageously includes both static flows and dynamic flows, such that a paging category can include one or more dynamic flows and one or more static flows.

Moreover, the base station 101 or other network infrastructure device can transmit the flow itself to the communication device 103. Therefore, the base station 101 can transmit the flow a single time. Accordingly, one or more embodiments provide for transmitting the flow (or flows) to the communication units, wherein the communication units have requested the flow (or flows).

The base station 101 or other communication infrastructure device can receive an indication in the conventional manner from the communication device 103 that the communication device 103 has requested a particular flow. Alternative embodiments provide that this indication can be provided, for example, from the communication network, e.g., the broadcast multicast controller 105, in a manner which provides for an indication of flows requested by particular communication devices.

In accordance with one or more embodiments, a dynamic flow, such as a group page, can be initiated by a communication device. The network infrastructure device, e.g., base station 101, can receive a page request from the communication device, where the page request is associated with a particular flow. Communication devices that are registered for that flow should be promptly awakened to receive the page. The page can be created in accordance with conventional techniques. Then, in accordance with one or more embodiments, the paging slot is determined for the page, e.g., by utilizing the flow identifier as described herein. The page can be scheduled for the paging slot. The communication devices that are in the group, e.g., the illustrated communication device 103, can receive the page in the paging slot.

Referring now to the communication device 103, the communication device can receive an indication of one or more paging categories, such as in a paging category map (further described below), that indicates flows and corresponding paging slots. The communication device 103 can determine one or more flows for which the communication device 103 is registered, e.g., by referring to registration indicators which have been stored in local memory when a user registered for the particular flows. Having determined the flows that are of interest to the communication device 103, the communication device can refer to the paging category map, and determine which paging slot is assigned to the flow or flows. The communication device 103 can then listen for one or more signals on the paging slot. Ideally, the flows are assigned so that the communication device 103 can listen to one paging slot and obtain all of the flows for which it is registered. Although it is anticipated that generally a communication device can listen to a single paging slot, nevertheless it is possible that flows can be assigned such that the communication device may need to listen to more than one flow.

The selection of flow identifiers will now be discussed with reference to the following example. For the purposes of illustration herein, the standard assumption is that BCMCS flow identifiers are 32 bit identifiers. Flows can be grouped together by assigning flow identifiers that hash to the same paging slot. By way of illustration, consider that f₁ and f₂ are two flows that multiple communication devices have registered to receive. Flow identifiers for f₁ and f₂ can be chosen such that f₁ and f₂ hash to the same paging slot. Pages for both f₁ and f₂ are therefore transmitted in the same paging slot. Furthermore, a conventional quick paging indicator positions for f₁ and f₂ would be different, such that communication devices monitoring only f₁ (or f₂) will not be woken up for pages sent for f₂ (or f₁). Conventionally, each paging slot is 80 ms and a paging slot cycle is a 2ⁱ×1.28 seconds, where i is the slot cycle index. Given a paging slot cycle length of 32 paging slots (2.56 seconds), there can be provided 2³²/32=2²⁷ flow identifiers per paging slot. Therefore, the example can be extended to multiple (more than two) flows.

The above-described approach for selecting flow identifiers works well for flows that can be pre-allocated, such as static flows. With flows that are established dynamically, possibly a proper choice is insufficient to ensure that a communication device can monitor a single broadcast paging slot. For example, suppose that communication unit MS₁ is monitoring paging slots for flow f₁ (e.g., a CNN broadcast), which hashes to paging slot n₁; and a communication unit MS₂ is monitoring paging slots for flow f₂ (e.g., an MTV broadcast), which hashes to paging slot n₂. A push-to-talk dispatch flow f₃ is to be made available in the network and both MS₁ and MS₂ are interested in it. With the above scheme, regardless of which paging slot f₃ hashes to, at least one of MS₁ and MS₂ will need to receive more than one paging slot. Utilization of paging categories, discussed below, can further reduce the number of paging slots that a communication device needs to monitor.

The designation flow group as used herein indicates a set of one or more flows that map to the same paging slot. If a communication device monitors the paging slot corresponding to a flow group, the communication device belongs to the flow group.

The designation paging category as used herein indicates a set of one or more flow groups, which can be static flow and/or one or more dynamic flows.

The designation paging category map as used herein indicates a set of one or more paging categories. In accordance with one or more embodiments, the paging category map includes an indication of flow groups, flow identifiers, and a paging slot to which they hash. Advantageously, the paging category can hash to the paging slot. The following table illustrates an example of a paging category map:

TABLE 1

| Paging | Flow | Flow | Flow | Dy- | Dy- | Dy- | |
|---|---|---|---|---|---|---|---|
| Cate- | group | group | group | namic | namic | namic | Refresh |
| gory | 1 | 2 | 3 | flow 1 | flow 2 | flow 3 | period |
| P-Cat 1 | 3 | | | f7 | f4 | | 3600 |
| P-cat 2 | 5 | 4 | | f8 | f5 | | 3600 |
| P-cat 3 | 2 | 1 | | f2 | | | 3600 |

In accordance with one or more embodiments, a particular flow can be assigned a broadcast address that is known to the communication devices that are interested in receiving the flow, e.g., such as when the communication device registers for the flow. Further, various embodiments can provide that, after obtaining the broadcast address, a communication device can be capable of receiving the flow on the appropriate traffic channel, e.g., a fundamental or a supplemental channel.

For flows that require paging (such as push-to-talk (direct connect)), the network infrastructure device can prepare a page message directed to one or more of the intended recipients of the flow (using the broadcast address for the flow). In accordance with one or more embodiments, the page message for individual flows can be transmitted over the paging channel (or alternatively the forward common control channel or the broadcast control channel). Advantageously, the slotted architecture of the overhead channels can be utilized to transmit the page message.

In accordance with one or more embodiments, one or more conventional quick paging indicators can be provided using known techniques on the quick paging channel to provide communication devices advance indication of a possible page on a given paging slot so that a communication device can wake up for their paging slot only when they have data.

Referring now to FIG. 2, a diagram illustrating portions of an exemplary network infrastructure device in accordance with various exemplary embodiments will be discussed and described. FIG. 2 is a diagram illustrating an exemplary network infrastructure device 201, such as a base station, in an exemplary communication network, e.g. The network infrastructure device 201 may include a controller 205, and a communication interface 225 for communicating with, e.g., communication devices. The controller 205 as depicted generally comprises a processor 209, a memory 211, and may include various other functionality that is not relevant but will be appreciated by those of ordinary skill.

The processor 209 may comprise one or more microprocessors and/or one or more digital signal processors. The memory 211 may be coupled to the processor 209 and may comprise one or more of a read-only memory (ROM), a random-access memory (RAM), a programmable ROM (PROM), an electrically erasable read-only memory (EEPROM) and/or magnetic memory or the like. The memory 211 may include multiple memory locations for storing, among other things, an operating system, data and variables 213 for programs executed by the processor 209; computer programs for causing the processor to operate in connection with various functions such as flow group assignment 215, paging category assignment 217, transmit paging category 219, and hash determination 221; and a database 223 for other information used by the processor 209. The computer programs may be stored, for example, in ROM, PROM, etc. and can direct the processor 209 in controlling the operation of the network infrastructure device.

One or more embodiments can provide for flow group assignment 215, and for paging category assignment 217. Both of these have been described above in detail.

The processor 209 can provide for transmitting the paging category 219. One or more embodiments provide for transmitting the paging category in a common control channel. Advantageously, the paging category can be included in or inserted into the conventional overhead that is provided in transmissions that are otherwise determined, e.g., in a control channel to a communication device.

In accordance with one or more embodiments, the processor 209 can provide for hash determination 221. Hash determination is explained in more detail in connection with FIG. 6. In overview, each of the flows can be assigned a flow identifier, where each of the flow identifiers hashes to the same paging slot.

Accordingly, there is provided a method for providing paging in a communication network, implemented in a network infrastructure device. When a group page is to be sent out to communication devices interested in receiving a particular flow f the network infrastructure device, e.g., the base station, can prepare a page message with the broadcast address for the flow f as a target. The network infrastructure device can transmit the page message on the paging slot to which the flow f hashes. The network infrastructure device then can determine a particular flow group F that contains the flow f and can transmit the page message on the paging slots corresponding to all the paging categories that include the flow group F.

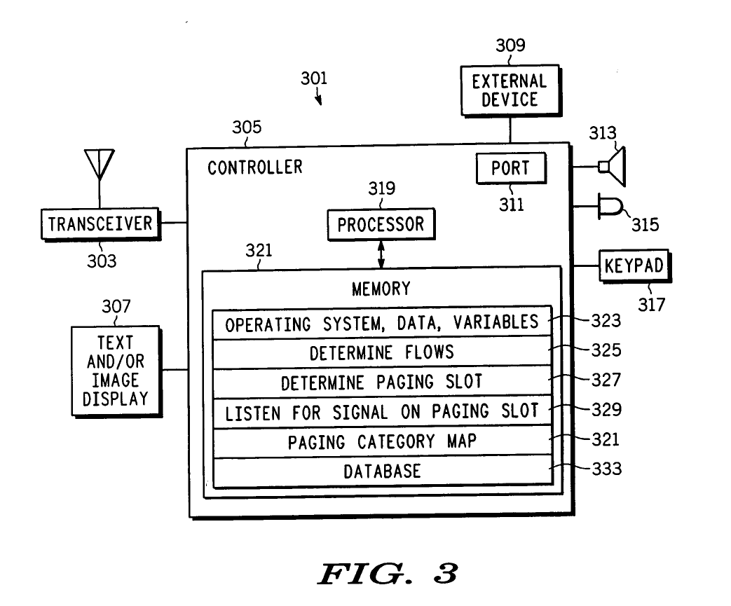

Referring now to FIG. 3, a diagram illustrating portions of an exemplary communication unit in accordance with various exemplary embodiments will be discussed and described. The communication device 301 may include a controller 305, a transceiver 303, and a communication port 311 for communication with an external device 309. The controller as depicted generally includes a processor 319, and a memory 321, and may include other functionality not illustrated for the sake of simplicity. The communication unit may further include, e.g., a speaker 313, a microphone 315, a text and/or image display 307, an alerting device (not illustrated) for providing vibratory alert, visual alert, or other alert, and/or a user input device such as a keypad 317.

The processor 319 may comprise one or more microprocessors and/or one or more digital signal processors. The memory 321 may be coupled to the processor 319 and may comprise a read-only memory (ROM), a random-access memory (RAM), a programmable ROM (PROM), and/or an electrically erasable read-only memory (EEPROM). The memory 321 may include multiple memory locations for storing, among other things, an operating system, data and variables 323 for programs executed by the processor 319; computer programs for causing the processor to operate in connection with various functions such as determining flow(s) 325, determining paging slots 327, listening for signal(s) on the paging slot 329, and/or other processing (not illustrated); storage for the paging category map 331; and a database 333 for other information used by the processor 319. The computer programs may be stored, for example, in ROM or PROM and may direct the processor 319 in controlling the operation of the communication device 301.

The processor 319 may be programmed to receive communications from the communication network in accordance with the transceiver 303. Communications can include, e.g., control channel information and data information.

Further, the processor 319 can be programmed for determining flow(s) 325 which the user desires to receive. For example, the user may have registered in accordance with applications provided on the process 319 for one or more particular flows, e.g., broadcast channel(s), and perhaps a group to which it subscribes. The user can also change the flows for which it is registered from time to time. Conventionally, the aforementioned application transmits the registration information to the communication network, so that the communication network can transmit pages accordingly. A local memory can be provided for storing information representative of the flows for which the communication device 301 is registered.

The processor 319 can be programmed for determining paging slots 327, which correspond to the flows for which the communication device 301 is registered. For example, the processor 319 can receive information over the transceiver 303, wherein the information is indicative of flows and corresponding paging slots. Advantageously, such information can be included in a paging category and/or in a paging category map. By referring to the flows, to which the communication device 301 is registered, and utilizing the information indicative of flows and corresponding paging slots, the processor 319 can determine the paging slots which are of interest to the communication device 301.

In addition, the processor 319 can be programmed for listening for signal(s) on the paging slot 329, in accordance with the transceiver 303. During times when the processor 319 is not listening for the signal on the paging slot 329, the processor 319 can power down the transceiver 303. A paging category prepared in accordance with one or more embodiments generally will indicate fewer paging slots than otherwise. The time in which the transceiver 319 can be powered down can be increased in comparison with conventional techniques. The memory 321 can include storage for the paging category map 331, which can be stored by the processor 319 after having received the paging category map via the transceiver 303.

The display 307 may present information to the user by way of a conventional liquid crystal display (LCD) or other visual display, and/or by way of a conventional audible device (e.g., the speaker 313) for playing out audible messages. The user may invoke functions accessible through the user input device 317, e.g., initiating a page to other communication devices, and/or registering for various flows. The user input device 317 may comprise one or more of various known input devices, such as a keypad as illustrated, a computer mouse, a touchpad, a touch screen, a trackball, and/or a keyboard. Responsive to signaling from the user input device 317, the processor 319 may direct information to be stored, e.g., storing information representative of the flows for which the user is registered. As another example, the processor 319 can be programmed or otherwise configured to interact with the user to determine one or more flows to register for. Moreover, when one or more flows are determined, the processor 319 can transmit one or more flows over the transceiver 303.

In accordance with one or more embodiments, if the communication device 301 does not wish to receive any dynamic flow, the communication device 301 can monitor the transceiver 303 for only the flow group that it belongs to. For example, if the communication device 301 is to receive only static flows, the flow identifiers can be selected in advance. Ideally, the flow identifiers are selected so that they hash to the same paging slot, so that the communication device 301 can belong to no more than one flow group.

In accordance with one or more embodiments, the communication device 301 optionally can receive one or more dynamic flows. Accordingly, the communication device 301 can receive the paging category map, and from the paging category map, determine the paging category it belongs to; determine a paging slot s that the paging category belongs to, e.g., by using a hash function (discussed below); monitor the paging slot s and (optionally) a dedicated paging slot corresponding to the communication device. Ideally, in accordance with one or more embodiments the communication device 301 can omit the monitoring of other paging slots. (It may be desirable for the communication device 301 to perform the conventional monitoring of its dedicated (e.g., uni-cast) paging slot independent of the procedures discussed herein.) When the communication device 301 receives a signal, e.g., via the transceiver 303, the signal can indicate that one or more pages are waiting to be retrieved by the communication device 301.

Instructions for implementing some of the foregoing can be provided on various computer-readable mediums. The instructions can include determining flows for which the communication device(s) are registered, as discussed above in connection with, e.g., FIG. 1-3. The instructions also can include establishing a paging category map, wherein the paging category map includes an indication of the flows and a paging slot corresponding thereto, as discussed in connection with, e.g., FIG. 1-3. Also, the instructions can provide for determining a paging slot for the flows, responsive to the paging category map, further as discussed in connection with, e.g., FIG. 1-3. In addition, the instructions can facilitate a reception of a signal on the paging slot, as discussed in connection with, e.g., FIG. 1-3.

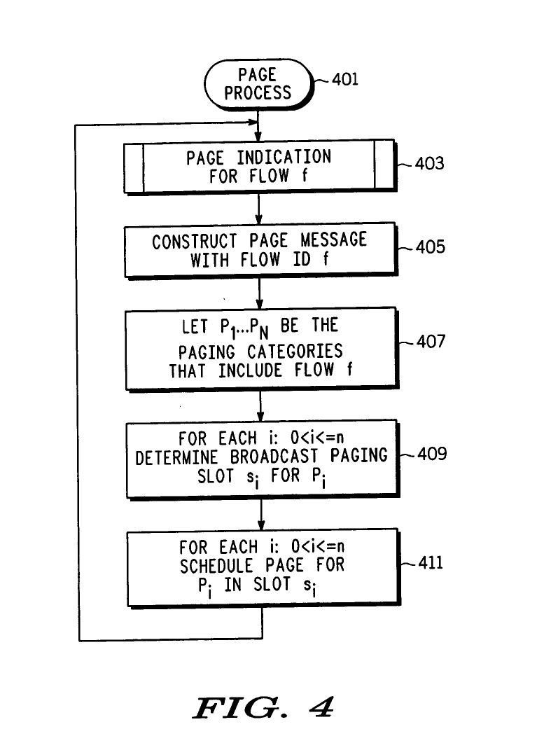

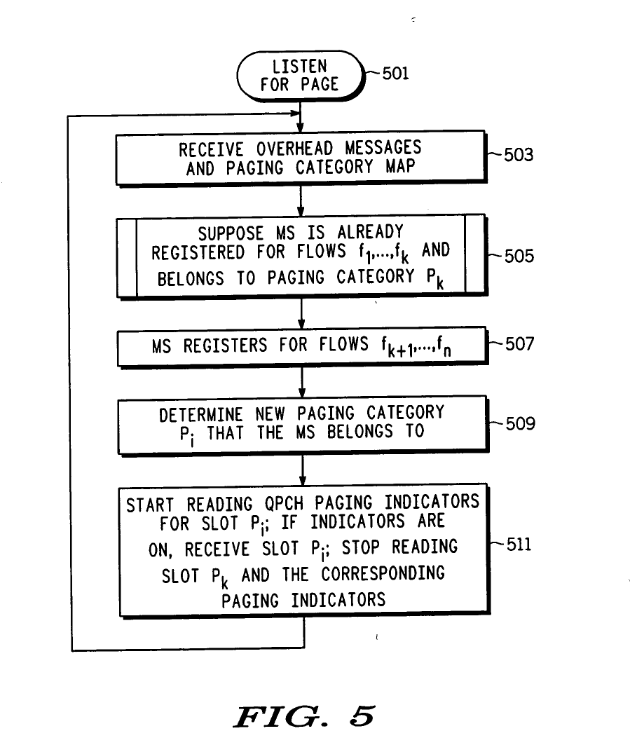

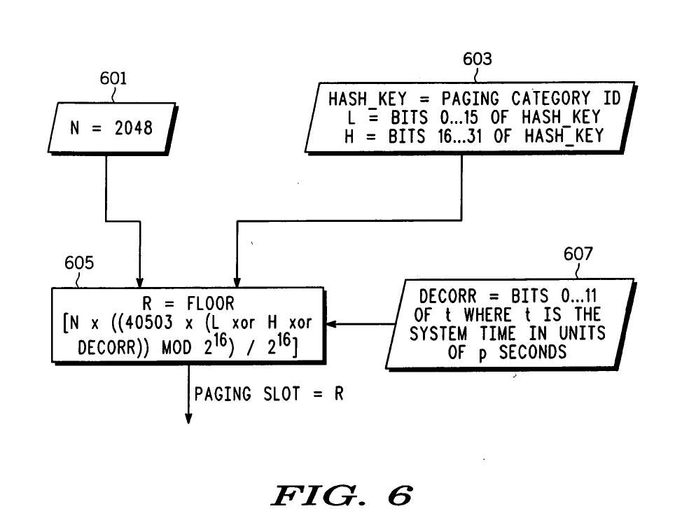

FIG. 4 and FIG. 5 provide flow charts illustrating procedures which can be utilized in connection with, e.g., dynamic flows. FIG. 4 and FIG. 5 can advantageously be implemented on the base station and the communication device, respectively.

Referring now to FIG. 4, a flow chart illustrating an exemplary page process 401 in accordance with various exemplary embodiments will be discussed and described. The procedure can, in accordance with at least one embodiment, be implemented on, for example, a processor of a network infrastructure device such as the base station described in connection with FIG. 2 or other apparatus appropriately arranged. For a flow f in flow group F, the process can provide for sending pages on all of the paging slots for the paging categories that contain flow group F.

In overview, the process can include receiving 403 a page indication for flow f constructing 405 a page message with a flow identifier corresponding to flow f, determining 407 the paging categories P₁-Pₙ, determining 409 the corresponding broadcast paging slots sᵢ for the paging categories, and scheduling 411 the page for each paging slot.

The page indication for flow f that is received 403, e.g., directly or indirectly from a communication device, can indicate that the base station or other network infrastructure device needs to communicate, e.g., by commencing a particular multicast (e.g., a page for a group) or a broadcast. The process can also include constructing 405 a page message with a flow identifier corresponding to flow f.

The process can also provide for determining 407 the paging categories P₁-Pₙ, as described previously, that need to include flow f. As in this illustration, a particular flow can be included in more than one paging category, which may be desirable where communication devices that are to receive the flow f are in different paging categories.

Further, the process can provide for determining 409 the broadcast paging slots sᵢ for 0<i<=n, for corresponding paging categories. Also, the process can provide for scheduling 411 the page in the respective paging slots. It will be appreciated that, because the paging slots have not changed, it is not necessary to re-transmit the paging categories. If one or more of the paging slots are changed, the paging category or paging category map can be transmitted, e.g., in the usual overhead to the communication devices.

Referring now to FIG. 5, a flow chart illustrating an exemplary procedure for listening for a page 501 in accordance with various exemplary and alternative exemplary embodiments will be discussed and described. The procedure can advantageously be implemented on, for example, a processor of a communication unit described in connection with FIG. 3 or other apparatus appropriately arranged. The process can provide for determining the paging category to which a communication device belongs, and setting up the communication device to actively listen to the paging category to which it belongs.

In overview, assume that a communication device is already registered 505 for particular flows. The listen for page process 501 can include receiving the paging category map 503, registering for one or more additional flows 507, determining a new paging category 509, and listening 511 on the paging slot corresponding to the paging category.

For the purpose of this illustration, assume that a communication device is already registered 505 for one or more particular flows f₁, . . . , fₖ, and that the communication device already belongs to a particular paging category Pₖ. Therefore, the communication device is already aware of the paging slots to which it should listen to receive the flows for which it is registered. For example, the process 501 may have received an overhead message with the paging category map 503.

In this example, the process provides for registering for one or more additional flows 507 fₖ₊₁, . . . , fₙ. The process can determine the paging category, such as a new paging category 509, which includes the additional flows and the existing flows, by referencing the paging category map or other indication of the flows and corresponding paging slots.

The process can provide for listening 511 on the paging slot corresponding to the paging category. For example, the process can provide for reading the quick paging channel (QPCH) paging indicators for the paging slot Pᵢ, and if the QPCH indicators are on, receiving information on the paging slot Pᵢ. Once the information is received on the paging slot, the process can provide for stopping monitoring of the paging slot, and stopping reading of the corresponding paging indicators. Accordingly, the process can provide for powering down a transceiver on a device receiving the information.

Referring now to FIG. 6, a flow chart illustrating an exemplary procedure for determining a hash in accordance with various exemplary and alternative exemplary embodiments will be discussed and described. The procedure can be used in connection with, e.g., the network infrastructure device described above, or other apparatus appropriate arranged.

In order to illustrate paging slot allocation, assume that the paging category map provides a unique 32 bit identifier for each paging category. The paging category identifier can be generated as a function of the constituent flow identifiers (if a paging category consists of a single flow, the paging category identifier can be the flow identifier itself). The paging slot for a particular paging category can be determined, e.g., by the communication device and/or the network infrastructure device, using a hash function as follows.

A hash key (HASH_KEY) 603 can be set to a particular paging category identifier, where L is the least significant bits 0 . . . 15 of the HASH_KEY, and R is the most significant bits 16 . . . 31 of the HASH_KEY. Alternatively, other standard hashing techniques can be utilized. A maximum number of paging slots N can be set 601 to 2048 (or other desired number of paging slots).

A de-correlation parameter (DECORR) 607 can be set to determine a de-correlation time periodicity, thereby to time shift a paging slot. For example, DECORR can be set to bits 0 . . . 11 of t, where t is the system time in units of p seconds, where p is the periodicity.

A paging slot R can be computed 605, for example as follows:
R=floor[N×((40503×(L xor H xor DECORR)) mod 2¹⁶)/2¹⁶]

R can then be used as the paging slot for the paging category.

In accordance with one or more embodiments, the paging category identifiers advantageously can be chosen such that they do not hash to paging slots that are already in use for flow groups or for other paging categories.

In accordance with one or more embodiments, a paging category can map to the same paging slot over the course of time. In order to provide a more equitable distribution of paging load it can be desirable to move the paging slots that correspond to the paging categories periodically. The broadcast paging slot for a given flow can be determined at any given time as follows. Let p be the time period between changes of the broadcast paging slots. For dynamic paging categories, the paging category map can carry a non-zero value for p to signal to the communication device(s) that the broadcast paging slot will change, or refresh, with periodicity p. Let t be the system time in units of p seconds. DECORR is set to the 12 least significant bits of t. R can be computed as above.

The refresh period for a particular paging category can be indicated to communication devices and the communication network, e.g., in a paging category map as illustrated for example in Table 1. Where there are multiple paging slots, the time shifting can occur in a pre-determined time period to another of the paging slots, and an indication of the time period can be transmitted to the communication device(s).

In accordance with the foregoing, a proper organization of flows can be provided in a communication network, whereby a communication device can reduce the number of broadcast paging slots that it monitors regardless of how many data flows it wishes to receive. Moreover, one or more embodiments provide for good distribution of pages across the paging slot cycle, thereby reducing or avoiding a paging overload on a particular paging slot.

It should be noted that the term communication unit may be used interchangeably herein with subscriber unit, wireless subscriber unit, wireless subscriber device or the like. Each of these terms denotes a device ordinarily associated with a user and typically a wireless communication device that may be used with a public network, for example in accordance with a service agreement, or within a private network such as an enterprise network. Examples of such units include personal digital assistants, personal assignment pads, and personal computers equipped for wireless operation, a cellular handset or device, or equivalents thereof.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest may have short range wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN using protocols such as TCP/IP, UDP/UP, IPX/SPX, or Net BIOS via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of providing paging in a communication network, implemented in a network infrastructure device, comprising:
first assigning a plurality of flows including at least one flow to at least one flow group, wherein the plurality of flows have a common paging slot; and
transmitting an indication of the common paging slot to at least one communication unit, wherein the at least one communication unit has requested the at least one flow.

2. The method of claim 1, further comprising second assigning a plurality of flow groups including the at least one flow group to at least one paging category, wherein the plurality of flow groups have the common paging slot, wherein the indication of the common paging slot is included in the paging category, and the paging category is transmitted.

3. The method of claim 2, wherein the at least one paging category includes at least one dynamic flow and at least one static flow.

4. The method of claim 2, wherein the at least one paging category is transmitted in at least one common control channel.

5. The method of claim 2, wherein the transmitting includes inserting the at least one paging category into an overhead of a predetermined transmission to the at least one communication unit.

6. The method of claim 1, further comprising transmitting the at least one flow to a plurality of communication units including the at least one communication unit, wherein the plurality of communication units have requested the at least one flow.

7. The method of claim 1, further comprising receiving at least one request from the at least one communication unit requesting the at least one flow.

8. The method of claim 1, wherein each flow of the plurality of flows is assigned a flow identifier, each of the flow identifiers hashing to the common paging slot.

9. The method of claim 1, further comprising time shifting the at least one paging slot.

10. The method of claim 9, wherein there are a plurality of paging slots including the common paging slot, and wherein the time shifting occurs in a pre-determined time period to another of the paging slots, further comprising transmitting an indication of the time period to the at least one communication unit.

11. The method of claim 1, wherein there are a plurality of paging slots including the common paging slot, further comprising, responsive to a received page request, creating a page, determining at least one paging slot for the page, and scheduling the page for the at least one paging slot.

12. A method of receiving paging in a communication network, implemented in a communication device, comprising:
receiving a paging category map;
first determining at least one flow for which the communication device is registered;
second determining at least one paging slot for the at least one flow, responsive to the paging category map; and
listening for at least one signal on the at least one paging slot.

13. The method of claim 12, wherein the paging category map includes an indication of the at least one flow and the at least one paging slot corresponding thereto.

14. The method of claim 12, further comprising receiving, on a transceiver on the communication device, the at least one signal.

15. The method of claim 12, wherein the at least one signal indicates that a page is waiting for the communication device.

16. The method of claim 12, wherein the at least one paging category includes at least one dynamic flow and at least one static flow.

17. A computer-readable medium comprising instructions being executed by a computer, the instructions including a computer-implemented method for scheduling paging directed to at least one communication device in a communication network, the instructions for implementing the steps of:
first determining a plurality of flows for which the at least one communication device is registered;
establishing a paging category map, wherein the paging category map includes an indication of the plurality of flows and a paging slot corresponding thereto;
second determining the paging slot for the plurality of flows, responsive to the paging category map; and
facilitating a reception of at least one signal on the paging slot.

18. The computer-readable medium of claim 17, wherein the at least one signal includes at least one dynamic flow and at least one static flow.

19. The computer-readable medium of claim 17, wherein the at least one signal includes a paging indication indicating that a page is waiting for at least one communication device.

20. The computer-readable medium of claim 17, further comprising instructions for powering down a transceiver of the at least one communication device for paging slots other than the paging slot.
